(19) United States
(12) Patent Application Publication
(10) Pub. No.: US 2014/0230633 A1
(43) Pub. Date: Aug. 21, 2014

(54) SYSTEM FOR WIRELESS OPERATION OF AN EXPRESSION PEDAL

(71) Applicant: FXCONNECTX, LLC, Holiday, FL (US)

(72) Inventors: Michael J. Vumbaco, Holiday, FL (US); James Arcidiacono, Holiday, FL (US)

(73) Assignee: FXCONNECTX, LLC, Holiday, FL (US)

(21) Appl. No.: 13/773,508

(22) Filed: Feb. 21, 2013

(51) Int. Cl. G10G 7/00

(52) U.S. Cl. CPC G10G 7/00
USPC 84/701

(57) ABSTRACT

A system for wireless operation of an expression pedal. In one embodiment a remote unit senses the position of an expression pedal and transmits the sensed expression pedal position information to a main unit. The main unit receives the sensed expression pedal position information and sets an adjustable element, to change an audio quality of an audio signal propagating through an external effects box, or of an audio signal propagating through the main unit.

### FIELD

One or more aspects of embodiments according to the present invention relate to control of audio effects, and more particularly to the control of audio effects using a wireless connection.

### BACKGROUND

Audio effects boxes providing various audio effects, such as distortion, wah, and delay, may be used by musicians when performing music in front of an audience or in a studio. Certain effects boxes may be configured to be controlled by an external control, such as an expression pedal, which may be operated by foot.

The use of a foot-operated expression pedal connected by a wire may lead to a need to use long cables. For example, if a musician is performing at the front of a stage and an effects box is connected between a preamplifier and a power amplifier, both of which are at the back of the stage, then, if the effects box is at the front of the stage, the audio signal must be brought from the preamplifier to the effects box at the front of the stage, and then back to the amplifier at the back of the stage. In an alternate setup, if the expression pedal controlling the effects box is at the front of the stage, and the preamplifier, effects box, and power amplifier are all at the back of the stage, a wire running from the front of the stage to the back of the stage is needed to connect the expression pedal to the effects box. These wires are inconvenient to set up, and they may be unreliable, and may impede the musician's ability to move about on a stage. Thus, there is a need for a system for connecting an expression pedal to an effects box using a wireless connection.

### SUMMARY

In one embodiment of the present invention, a remote unit is configured to be connected to an expression pedal, and to transmit information about the position of the expression pedal to a main unit, which then mimics the behavior of the expression pedal to an effects box to which the main unit is connected, providing, for example, a voltage corresponding to the position of the expression pedal.

According to an embodiment of the present invention there is provided a system for wireless control of a continuously adjustable audio quality, including: a main unit; and a first remote unit connected to the main unit by a wireless link; the first remote unit configured to sense a position of an expression pedal and to transmit sensed expression pedal position information to the main unit; and the main unit configured to set an adjustable element in response to the expression pedal position information received from the first remote unit to adjust the continuously adjustable audio quality.

In one embodiment, the first remote unit is configured to connect to the expression pedal via a first conductor, a second conductor, and a third conductor, and the first remote unit is configured sense the position of the expression pedal by: providing a reference voltage on the first conductor; providing a ground reference on the second conductor; and obtaining an indicator voltage, corresponding to the position of the expression pedal, on the third conductor.

In one embodiment, the first remote unit is configured to connect to the expression pedal via a tip-ring-sleeve (TRS) connector having a tip, a ring, and a sleeve.

In one embodiment, the first remote unit includes an analog to digital converter (ADC), configured to convert the indicator voltage to a digital representation of the indicator voltage.

In one embodiment, the ADC is configured to convert the indicator voltage repeatedly, to a digital representation of the indicator voltage, at a rate of at least 10 conversions per second.

In one embodiment, the first remote unit is configured to transmit the sensed expression pedal position information when a digital representation of an indicator voltage differs by more than a threshold amount from the most recent previously transmitted digital representation of the indicator voltage.

In one embodiment, the first remote unit is configured to transmit the sensed expression pedal position information when a time interval has elapsed since the last time the first remote unit transmitted the sensed expression pedal position information.

In one embodiment, the time interval is 10 seconds.

In one embodiment, the ADC is configured to convert the indicator voltage to a 16-bit digital representation of the indicator voltage.

In one embodiment, the adjustable element is a digital potentiometer.

In one embodiment, the main unit is configured to be connected to an effects device via a three-conductor tip-ring-sleeve (TRS) connector.

In one embodiment, the main unit is configured to be connected to an effects device via an XLR connector.

In one embodiment, the main unit is configured to be connected to an effects device via a Deutsches Institut für Normung (DIN) connector.

In one embodiment, the first remote unit is permanently configured with a unique security code; and each transmission of sensed expression pedal position information is part of a transmitted data packet including the unique security code.

In one embodiment, the remote unit is configured to be configurable with any of 4.2 billion possible security codes.

In one embodiment, the main unit is configured to transition, upon receipt of appropriate user input, temporarily into a learn state, wherein, when operating in the learn state, the main unit is configured to acquire and store, in the main unit, a received security code.

In one embodiment, when not in the learn state, the main unit is configured to respond only to transmitted data packets including a security code stored in the main unit.

In one embodiment, the main unit and the first remote unit each include a battery-based source of backup power.

In one embodiment, the adjustable element is a variable-gain element.

In one embodiment, the main unit includes an audio input connector and an audio output connector, and the main unit is configured to set, in response to expression pedal position information received from the first remote unit, the gain or attenuation of an audio signal propagating from the audio input connector to the audio output connector.

In one embodiment, the adjustable element is a multiplying digital to analog converter (DAC).

In one embodiment, the adjustable element is a digital potentiometer configured as a variable attenuator.

In one embodiment, the system includes a second remote unit, wherein the main unit is configured to set the adjustable element in response to the most recently received expression pedal position information from a remote unit.

In one embodiment, the wireless link is a bidirectional wireless link.

In one embodiment, the main unit is configured to transmit a status message periodically.

In one embodiment, the status message includes an indication of the setting of the adjustable element.

In one embodiment, the first remote unit includes a status indicator to indicate recent reception of a status message from the main unit.

In one embodiment, the status indicator is a light emitting diode (LED) configured to emit light when a status message has been received during a preceding time interval.

In one embodiment, the time interval is less than 10 seconds.

In one embodiment, the main unit is configured to: detect an error condition in the first remote unit; and disregard the expression pedal position information received from the first remote unit after detecting the error condition.

In one embodiment, the error condition includes a change, exceeding a threshold, in two consecutive samples of the expression pedal position information received from the first remote unit.

In one embodiment, the error condition includes a message received from the remote unit indicating low remaining battery life.

In one embodiment, the error condition includes a change, less than a threshold, in two or more consecutive samples of the expression pedal position information received from the first remote unit.

### BRIEF DESCRIPTION OF THE DRAWINGS

Features, aspects, and embodiments are described in conjunction with the attached drawings, in which:

FIG. 1 is a schematic block diagram of a system for wireless control of an effects pedal or an effects box by an expression pedal according to an embodiment of the present invention; and

FIG. 2 is a schematic block diagram of a system for wireless control of an effects pedal or an effects box by an expression pedal according to another embodiment of the present invention.

### DETAILED DESCRIPTION

The detailed description set forth below in connection with the appended drawings is intended as a description of exemplary embodiments of a system for wireless operation of an expression pedal provided in accordance with the present invention and is not intended to represent the only forms in which the present invention may be constructed or utilized. The description sets forth the features of the present invention in connection with the illustrated embodiments. It is to be understood, however, that the same or equivalent functions and structures may be accomplished by different embodiments that are also intended to be encompassed within the spirit and scope of the invention. As denoted elsewhere herein, like element numbers are intended to indicate like elements or features.

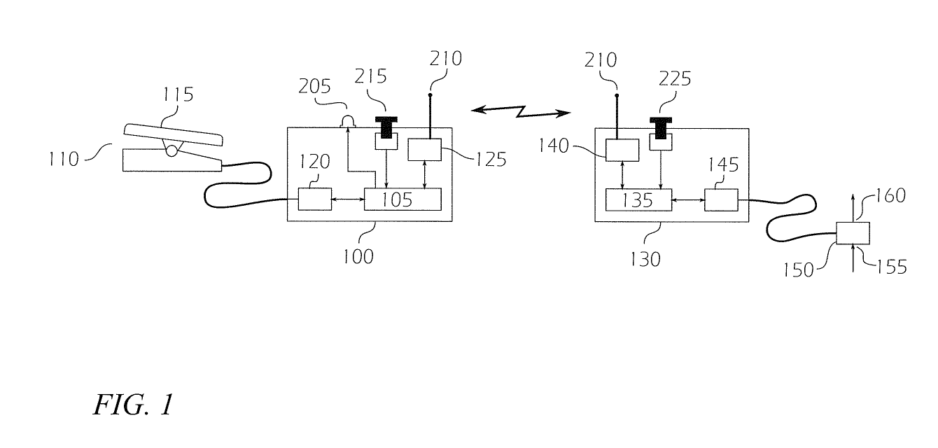

Referring to FIG. 1, in one embodiment of the present invention, an expression pedal 110 is connected to a remote unit 100, which is in wireless communication with a main unit 130, which in turn is connected to a component for modifying an audio signal. Such a component may be referred to as an effects pedal or an effects box 150. The expression pedal 110, which may for example be a Boss EV-5 expression pedal available from Roland Corporation U.S., of Los Angeles, Calif., has a pivot about which a continuously adjustable platform 115 may rotate when moved by the foot of a musician. The expression pedal 110 may be connected to the remote unit 100 by plugging a cable into the expression pedal 110 and into a remote unit 100 connector which may, for example, be a tip-ring-sleeve (TRS) connector, an XLR connector, or a Deutsches Institut für Normung (DIN) connector.

The expression pedal 110 is connected to the remote unit 100 in a manner allowing a remote unit controller 105 to detect the position of the continuously adjustable platform 115. In one embodiment, the expression pedal 110 contains a potentiometer, and the remote unit 100 contains a remote unit sensing element 120, which provides a reference voltage to one end terminal of the potentiometer, and a connection to ground for the other end terminal of the potentiometer. The potentiometer is mechanically connected to the continuously adjustable platform 115, so that the voltage of the wiper of the potentiometer is a function of the position of the continuously adjustable platform 115 of the expression pedal 110. The wiper of the potentiometer is connected to a sensing input of the remote unit sensing element 120, and the remote unit sensing element 120 may sense this voltage and convert it to digital form with an analog to digital converter (ADC), and communicate the sensed voltage to a remote unit controller 105, which may be a microprocessor or microcontroller. In one embodiment the ADC senses the voltage of the wiper, and, thereby, the position of the continuously adjustable platform 115, at a rate of at least 10 samples per second, so that when a musician makes a change to the position of the continuously adjustable platform 115, the change is promptly sensed and communicated to the remote unit controller 105.

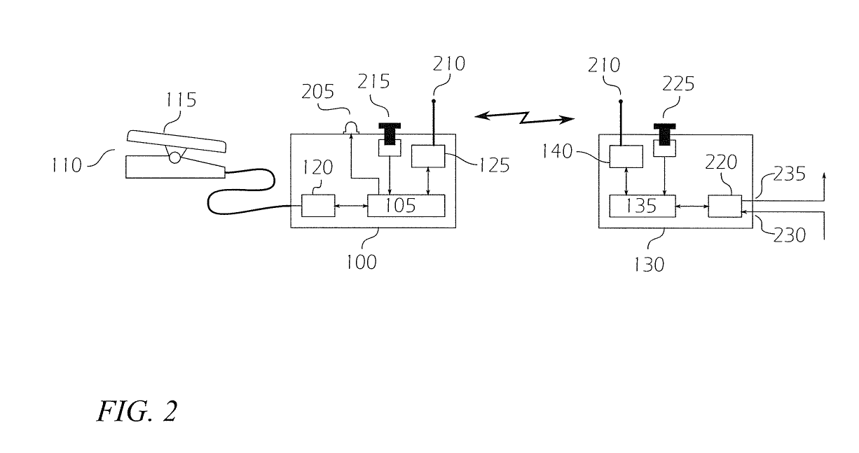

In operation, information about the position of the continuously adjustable platform 115 is communicated by the remote unit 100 to the main unit 130 over a wireless connection, and, in response, the main unit 130 adjusts an aspect of an audio signal accordingly. In one embodiment, the remote unit 100 includes a remote unit wireless transceiver 125 connected to the remote unit controller 105. The remote unit wireless transceiver 125 is in communication with a main unit wireless transceiver 140, in the main unit 130. The remote unit wireless transceiver 125 and the main unit wireless transceiver 140 may each be equipped with an antenna 210 to improve the range of this wireless communication link. The main unit 130 also contains a main unit controller 135 and an adjustable element, which may be referred to as an audio control element. The audio control element may be an effects box control element 145 or a volume control element 220 (FIG. 2). The effects box 150 has an effects box audio input 155, and an effects box audio output 160, and it modifies an audio signal propagating through it in accordance with a control voltage received from the main unit 130. For example, the effects box 150 may be a digital delay with a continuously adjustable delay time, controlled by the signal from the main unit 130. As used herein, a continuously adjustable audio quality refers to any aspect of an audio signal modification which may vary continuously, such as volume or delay, even if, as implemented in a particular effects box 150, the continuously adjustable audio is adjusted in small discrete increments. Thus, audio volume is referred to herein as a continuously adjustable audio quality even if it is implemented in an effects box 150 using an 8-bit (i.e., 256-step) multiplying digital to analog converter (DAC).

The effects box control element 145 is an element configured to control an effects box 150 external to the main unit 130. In one embodiment, this control is accomplished through a control voltage provided by the effects box control element 145 to the effects box 150. The effects box control element 145 may contain a digital potentiometer, with a first end terminal connected to a voltage source provided by the effects box 150, a second end terminal connected to ground, and the wiper of the digital potentiometer may provide a control voltage to the effects box 150. The effects box control element 145 may in turn be controlled by the main unit controller 135, which may control the effects box control element 145 in response to information received from the remote unit 100 via the wireless link provided by the remote unit wireless transceiver 125 and the main unit wireless transceiver 140. Thus, in one embodiment, the effect, in operation, of moving the continuously adjustable platform 115 of the expression pedal 110 may be the same as if the expression pedal 110 were directly connected to the effects box 150, with a wire. When the musician adjusts the position of the continuously adjustable platform 115, the new position is sensed by the remote unit sensing element 120, communicated to the remote unit controller 105, sent by the remote unit controller 105 to the remote unit wireless transceiver 125, transmitted wirelessly to the main unit wireless transceiver 140, and read by the main unit controller 135. The main unit controller 135 then controls the effects box control element 145 to provide a control voltage to the effects box 150, the control voltage being similar to the voltage the expression pedal 110 would have provided, were it connected directly to the effects box 150.

In other embodiments, as will be apparent to one of skill in the art, the effects box control element 145 may have an internal reference voltage, which may, instead of a reference voltage from the effects box 150, be connected to a digital potentiometer, or the effects box control element 145 may employ a DAC, or a multiplying DAC using a reference voltage from the effects box 150, to generate the control voltage.

Referring to FIG. 2, in another embodiment, the main unit 130 may include a volume control element 220, and an audio signal may enter the main unit 130 at a main unit audio input 230, propagate through the volume control element 220, and exit at a main unit audio output 235. The volume control element 220 is a variable gain or attenuation element, which, when adjusted, causes the volume of the audio signal propagating out of the main unit audio output 235 to change accordingly. It may be constructed, for example, using a digital potentiometer configured as a variable attenuator, viz. with one end terminal connected to ground, with the other end terminal connected to the main unit audio input 230, and with the wiper connected to the main unit audio output 235. In another embodiment, the volume control element 220 may be constructed using a multiplying DAC. The main unit controller 135, in controlling the volume control element 220, may set its gain or attenuation to be simply proportional to the position of the continuously adjustable platform 115, or it may set it in accordance with another function, such as an exponential function, to emulate the behavior of a volume control using an audio taper potentiometer.

Both the main unit 130 and the remote unit 100 may be battery powered or powered by line power, which may also be referred to as AC power or wall power. If the main unit 130 or the remote unit 100 is powered by line power, it may have a battery-based power supply as well, which may operate as backup power in case of line power failure, or as the principal source of power when the unit is not connected to line power.

In one embodiment, the remote unit 100 may cease transmitting expression pedal position information, i.e., data representing the position of the continuously adjustable platform 115, or it may transmit expression pedal position information less frequently, when this position is constant or nearly constant, as may be the case if the musician's foot is not in contact with the continuously adjustable platform 115. In this case, ceasing transmission or reducing the frequency of transmissions may prolong the life of a battery powering the remote unit 100.

The main unit wireless transceiver 140 may periodically transmit a status message back to the remote unit wireless transceiver 125 to acknowledge successful receipt of data from the remote unit wireless transceiver 125. This status message may include information regarding the setting of the audio control element. The remote unit 100 may have a status indicator 205, which may be an LED, or an LED capable of displaying several colors, such as red, yellow, and green. The status indicator 205 may provide status information to the user, for example by turning green when the user is operating the expression pedal 110 and the remote unit 100 is receiving, from the main unit 130, status messages indicating correct receipt of expression pedal position information. The status indicator 205 may turn yellow when the pedal has been idle for some time, and it may turn red when the remote unit 100 has not received an expected status message from the main unit 130 or when the remote unit 100 has received a status message from the main unit 130 indicating an error condition, or when the remote unit 100 has itself detected an error condition, such as inadequate battery power.

Data transmitted from the remote unit wireless transceiver 125 to the main unit wireless transceiver 140 may be transmitted in packets, with each packet containing a security code. The security code may be unique to the remote unit wireless transceiver 125. This uniqueness may be insured during the manufacturing process, when the remote unit wireless transceiver 125 is fabricated, for example, or when the remote unit wireless transceiver 125 is configured and integrated into the remote unit 100. In one embodiment, the security code may be of sufficient length, in bits, to provide 4.2 billion different possible security codes.

The main unit 130 may be configured to accept data transmissions containing certain security codes and to ignore all other data transmissions. This may be accomplished using a pairing process which may also be referred to as a learn, or learning, process. To support this process, the main unit 130 may be equipped with a learn button 225, and the remote unit 100 may have a transmit button 215. To pair the main unit 130 with a remote unit 100, i.e., to teach the main unit 130 to accept input from the remote unit 100, the user may first remove the antenna 210 from each unit, place the remote unit 100 near the main unit 130, and press and hold the learn button 225 on the main unit 130, thereby holding the main unit 130 in a learn state while the learn button 225 is held. The user may then briefly press the transmit button 215 on the remote unit 100, while continuing to hold the learn button 225 on the main unit 130. The remote unit 100 will transmit its security code each time the transmit button 215 is pressed, and the main unit controller 135 will, while the learn button 225 is pressed, i.e., while it is in the learn state, store in nonvolatile memory any security codes it receives. Thus, this process will cause the main unit 130 to store the security code of the remote unit 100. Subsequently, the main unit 130 will accept data transmissions containing the stored security code. A mechanism may be provided allowing the user to clear all stored security codes from the main unit's nonvolatile memory, e.g., by pressing another button provided for this purpose on the main unit 130, by pressing a combination or sequence of buttons, or by pressing and holding a button for an extended time.

More than one remote unit 100 may be used concurrently or simultaneously with one main unit 130. For example, a musician may wish to be able to control the audio volume from either stage left or stage right. In this case, the main unit 130 may be paired with two remote units 100, and the remote units 100 may be positioned as desired. In operation, the main unit 130 may use the expression pedal position information most recently received from an expression pedal 110 being operated by a musician, as determined, by the main unit 130, by the receipt of a series of changing data values from the corresponding remote unit 100.

The main unit 130 may be configured to detect and respond to various possible error conditions in a remote unit 100. For example if an expression pedal 110 has a faulty, e.g., dirty, potentiometer, the expression pedal position information received from the corresponding remote unit 100 by the main unit 130 may fluctuate rapidly, e.g., as dirt particles in the potentiometer intermittently interrupt the electrical contact between the potentiometer wiper and the resistive element. In other examples, the remote unit 100 may transmit a message to the main unit 130 indicating that the remote unit battery is running low, or it may transmit expression pedal position information differing only slightly from recently sent transmit expression pedal position information, so that the main unit 130 may infer that the change is due to the expression pedal 110 having been inadvertently bumped, or to noise in the remote unit sensing element 120. In one embodiment, when the main unit 130 detects any such error condition, it sends a notification to the affected remote unit 100, and it disregards further expression pedal position information received from the affected remote unit 100, either during some time interval, or until a reset event occurs, such as a user reset or a transmission from the affected remote unit 100 indicating that the error condition has been resolved. When the affected remote unit 100 receives the notification from the main unit 130, it may indicate to the user, with the remote unit 100 status indicator 205, that it has been disabled, e.g., by turning the status indicator 205 red.

Several main units 130 may be combined in one enclosure to save space and to share certain functions or components, such as a power supply. One or more main units 130 in an enclosure may be referred to as a main unit box. A main unit box may, for example, contain two main units 130 configured with effects box control elements 145 and one main unit 130 configured with a volume control element 220.

It should be appreciated from the above that various structures and functions described herein may be incorporated into a variety of apparatus. In some embodiments, hardware components such as processors, controllers, and/or logic may be used to implement the described components or circuits. In some embodiments, code such as software or firmware executing on one or more processing devices may be used to implement one or more of the described operations or components.

Although limited embodiments of a system for wireless operation of an expression pedal have been specifically described and illustrated herein, many modifications and variations will be apparent to those skilled in the art. Accordingly, it is to be understood that the system for wireless operation of an expression pedal employed according to principles of this invention may be embodied other than as specifically described herein. The invention is also defined in the following claims, and equivalents thereof.

What is claimed is:

1. A system for wireless control of a continuously adjustable audio quality, comprising:
a main unit; and
a first remote unit connected to the main unit by a wireless link;
the first remote unit configured to sense a position of an expression pedal and to transmit sensed expression pedal position information to the main unit; and
the main unit configured to set an adjustable element in response to the expression pedal position information received from the first remote unit to adjust the continuously adjustable audio quality.

2. The system of claim 1, wherein the first remote unit is configured to connect to the expression pedal via a first conductor, a second conductor, and a third conductor, and the first remote unit is configured sense the position of the expression pedal by:
providing a reference voltage on the first conductor;
providing a ground reference on the second conductor; and
obtaining an indicator voltage, corresponding to the position of the expression pedal, on the third conductor.

3. The system of claim 2, wherein:
the first remote unit is configured to connect to the expression pedal via a tip-ring-sleeve (TRS) connector having a tip, a ring, and a sleeve.

4. The system of claim 2, wherein the first remote unit comprises an analog to digital converter (ADC), configured to convert the indicator voltage to a digital representation of the indicator voltage.

5. The system of claim 4, wherein the ADC is configured to convert the indicator voltage repeatedly, to a digital representation of the indicator voltage, at a rate of at least 10 conversions per second.

6. The system of claim 5, wherein the first remote unit is configured to transmit the sensed expression pedal position information when a digital representation of an indicator voltage differs by more than a threshold amount from the most recent previously transmitted digital representation of the indicator voltage.

7. The system of claim 6, wherein the first remote unit is configured to transmit the sensed expression pedal position information when a time interval has elapsed since the last time the first remote unit transmitted the sensed expression pedal position information.

8. The system of claim 7, wherein the time interval is 10 seconds.

9. The system of claim 4, wherein the ADC is configured to convert the indicator voltage to a 16-bit digital representation of the indicator voltage.

10. The system of claim 1, wherein the adjustable element is a digital potentiometer.

11. The system of claim 10, wherein the main unit is configured to be connected to an effects device via a three-conductor tip-ring-sleeve (TRS) connector.

12. The system of claim 10, wherein the main unit is configured to be connected to an effects device via an XLR connector.

13. The system of claim 10, wherein the main unit is configured to be connected to an effects device via a Deutsches Institut für Normung (DIN) connector.

14. The system of claim 1, wherein:
the first remote unit is permanently configured with a unique security code; and
each transmission of sensed expression pedal position information is part of a transmitted data packet comprising the unique security code.

15. The system of claim 14, wherein the remote unit is configured to be configurable with any of 4.2 billion possible security codes.

16. The system of claim 14, wherein the main unit is configured to transition, upon receipt of appropriate user input, temporarily into a learn state, wherein, when operating in the learn state, the main unit is configured to acquire and store, in the main unit, a received security code.

17. The system of claim 16, wherein when not in the learn state, the main unit is configured to respond only to transmitted data packets comprising a security code stored in the main unit.

18. The system of claim 1, wherein the main unit and the first remote unit each comprise a battery-based source of backup power.

19. The system of claim 1, wherein the adjustable element is a variable-gain element.

20. The system of claim 19, wherein the main unit comprises an audio input connector and an audio output connector, and the main unit is configured to set, in response to expression pedal position information received from the first remote unit, the gain or attenuation of an audio signal propagating from the audio input connector to the audio output connector.

21. The system of claim 20, wherein the adjustable element is a multiplying digital to analog converter (DAC).

22. The system of claim 20, wherein the adjustable element is a digital potentiometer configured as a variable attenuator.

23. The system of claim 1, comprising a second remote unit, wherein the main unit is configured to set the adjustable element in response to the most recently received expression pedal position information from a remote unit.

24. The system of claim 1, wherein the wireless link is a bidirectional wireless link.

25. The system of claim 24, wherein the main unit is configured to transmit a status message periodically.

26. The system of claim 25, wherein the status message comprises an indication of the setting of the adjustable element.

27. The system of claim 25, wherein the first remote unit comprises a status indicator to indicate recent reception of a status message from the main unit.

28. The system of claim 27, wherein the status indicator is a light emitting diode (LED) configured to emit light when a status message has been received during a preceding time interval.

29. The system of claim 28, wherein the time interval is less than 10 seconds.

30. The system of claim 1, wherein the main unit is configured to:
detect an error condition in the first remote unit; and
disregard the expression pedal position information received from the first remote unit after detecting the error condition.

31. The system claim 30, wherein the error condition comprises a change, exceeding a threshold, in two consecutive samples of the expression pedal position information received from the first remote unit.

32. The system of claim 30, wherein the error condition comprises a message received from the remote unit indicating low remaining battery life.

33. The system of claim 30, wherein the error condition comprises a change, less than a threshold, in two or more consecutive samples of the expression pedal position information received from the first remote unit.
